(19) United States
(12) Patent Application Publication
(10) Pub. No.: US 2008/0162526 A1
(43) Pub. Date: Jul. 3, 2008

(54) METHOD AND SYSTEM FOR MANAGING UNSTRUCTURED DATA IN A STRUCTURED DATA ENVIRONMENT

(76) Inventor: Uma Kant Singh, Bangalore (IN)

Correspondence Address: SAP AG, 3410 HILLVIEW AVENUE, PALO ALTO, CA, 94304, US

(21) Appl. No.: 11/617,711

(22) Filed: Dec. 28, 2006

(51) Int. Cl. G06F 17/30

(52) U.S. Cl. 707/102; 707/3; 707/E17.005

(57) ABSTRACT

A method and system for managing pin-up notes, wherein a data identifier ID is provided for a set of data. The pin-up notes mapped to the retrieved data identifier are retrieved responsive to providing the data identifier. A pin-up note is generated by a user and mapped to the retrieved data identifier.

### TECHNICAL FIELD

Embodiments of the invention generally relate to the field of recording, managing and linking annotations to a set of data and, more particularly, to a method and system for managing unstructured data in a structured data environment.

### BACKGROUND

It is often desirable to associate unstructured information such as notes with data objects. Such notes may include a description of the contents of the data objects, instructions or comments to people working with the data objects, project notes, etc. There are also scenarios when a user needs to gather the unstructured information with respect to a transaction and then later convert this unstructured information into structured data. An example of the above scenario may be a customer service executive on a service call with a customer. Due to time and resource limitations the executive may not always able to capture and document the entire conversation with the customer as structured data. Thus, the executive may require an easy way to capture the conversation as unstructured data and then convert it into structured data at a later time.

Another example of the above scenario may be an employee of an organization on a business tour. The employee may not want to record all of the transactions as structured data such as taxi charges, hotel charge etc immediately after each transaction. The employee may prefer to store the transactions as unstructured data and generate structured data referring the pre-recorded unstructured data at a later stage (e.g., after trip completion).

Systems are available which enable users to generate unstructured data by way of notes or annotations. For example, these systems allow a user to record a number of notes and store them in a generic pool without any association. The user may then refer the generic pool of notes and search for the required information by navigating and reading each note. This is a very tedious process and consumes lot of time.

There are also systems available which allow a user to generate and link notes to user interface UI screens. Thus when the user navigates to a UI screen, the notes linked to the screen are retrieved and displayed. Although these systems allow linking notes to UI screens, they do not allow linking to the underlying data displayed in the screens.

There are also systems in which text input fields are provided to enable a user to enter and save text information for later reference. These input fields are hard coded and customized for a particular application. However, these systems do not allow the user to record and attach notes in various formats such as voice, video, presentation, spreadsheet, pictures, etc. Further, as the input fields are customized for a particular application, they are not used to record notes across applications.

### SUMMARY OF THE INVENTION

Embodiments of the invention are generally directed to a method and system for managing unstructured data within a structured data environment. A data identifier ID is provided for a set of data. Unstructured data is created and then mapped to the data identifier ID. The unstructured data mapped to the data identifier may then be retrieved and displayed.

These and other benefits and features of embodiments of the invention will be apparent upon consideration of the following detailed description of preferred embodiments thereof, presented in connection with the following drawings in which like reference numerals are used to identify like elements throughout.

### BRIEF DESCRIPTION OF THE DRAWINGS

The claims set forth the embodiments of the invention with particularity. The embodiments of the invention, together with its advantages, may be best understood from the following detailed description taken in conjunction with the accompanying drawings. The invention is illustrated by way of example and not by way of limitation in the figures of the accompanying drawings. It should be noted that references to “an” or “one” embodiment in this disclosure are not necessarily to the same embodiment, and such references mean at least one.

FIG. 1 illustrates a functional block diagram of a system for generating and recording unstructured data such as pin-up notes according to one embodiment of the invention.

FIG. 2 illustrates a preferred implementation of the functional block diagram in FIG. 1 according to an embodiment of the invention.

FIG. 3 illustrates a flow diagram to explain the high level process flow for unstructured data retrieval and generation according to a preferred embodiment of the invention.

FIG. 4 illustrates a flow diagram to explain the process flow during unstructured data generation and mapping in accordance with a preferred embodiment of the invention.

FIG. 5 illustrates a flow diagram to explain the process flow during unstructured data retrieval according to a preferred embodiment of the invention.

FIG. 6 illustrates an exemplary block diagram of a system useful for implementing one embodiment of the invention.

FIG. 7 illustrates a format in which the unstructured data is stored in the database according to a preferred embodiment of the invention.

### DETAILED DESCRIPTION

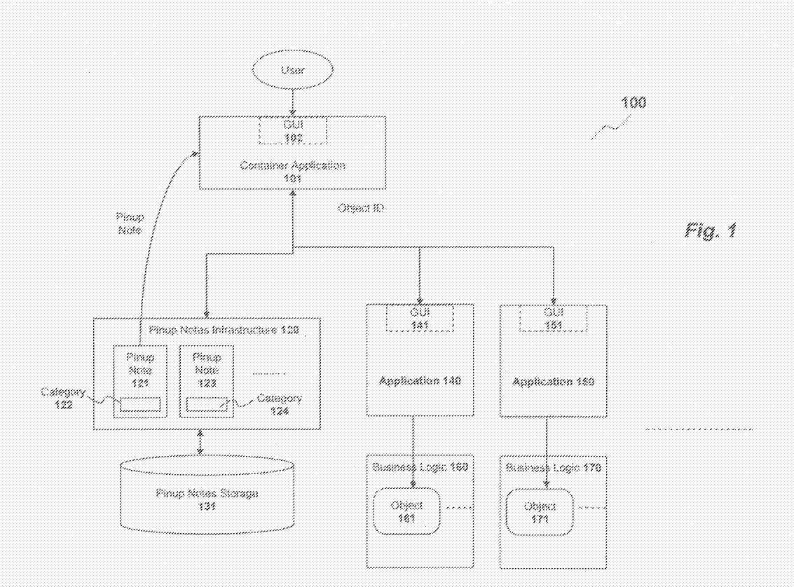

FIG. 1 illustrates a functional block diagram 100 of one embodiment of a system for generating and recording a particular type of unstructured data, referred to herein as “pinup notes,” which may be in any unstructured data format supported by the system (e.g., text data, voice recording, video recording, a presentation format, a spreadsheet format, etc). Although the remainder of this detailed description will use the term “pinup notes,” it should be noted that the underlying principles of the invention are not limited to any particular type of unstructured data. In FIG. 1, a container application 101 acts as a portal for a number of other applications. The container application has its own GUI 102 (Graphical User Interface) to enable a user to interact with the system. The container application 101 at any time may access and act as a host to more than one application upon user request. Applications 140 and 150 may be accessed by the container application 101 upon user request. Thus the container application 101 acts as an interface between the user and applications 140 and 150, enabling the user to access more than one application through one GUI 102. Each application 140 and 150 has business logic 160 and 170, respectively, associated with it. The business logic 160 and 170 may comprise of a number of data objects (also called “business objects” or “business object types”). For example, data object 161 is a part of business logic 160 associated with application 140 and data object 170 is a part of business logic 170 associated with application 150. The applications 140 and 150 have their own GUIs 141 and 151, respectively. GUI 102 may provide the user with a means to select data objects which are part of business logic 160 and 170. For example, if the user requests access to the data object 161 which is a part of business logic 160 through GUI 102, the container application 101 invokes the application 140 and retrieves and displays its GUI 141. The user then effectively works on GUI 141 to access the data objects associated with business logic 160. Thus, the container application 101 acts as a host to application 140 and GUI 102 acts as a host to GUI 141. The container application 101 is further coupled to a pin-up notes infrastructure 120 which enables generation, retrieval, mapping and management of unstructured data in the form of pinup notes.

An example of a container application 102 may be the corporate portal for an organization. Applications 140 and 150 may be applications such as employee services, organization portfolio, address book, help, etc., hosted by the organization portal. GUI 102 may be the user interface for the portal and GUIs 141 and 151 may be the user interface screens of each of the applications 140 and 150. Assuming that application 140 is an application for management of employee services in an organization, using this application, a user may access all, or a subset of, the employee services offered by the organization. Each of the employee services such as compensation, travel services, orders and purchases, vacation and time-off, IT services etc is a data object such as object 161. An employee may access any of the business object types and create multiple instances of each type. For example if the employee accesses the business object types “vacation” and “time off,” an object instance is generated for each. The GUI screens 141 and 151, object types 161 and 171 and instances of each object type have unique identification codes (“IDs”) associated with each of them.

The pin-up notes infrastructure 120 retrieves IDs of currently active application UI screens, object types or object instances. The pin-up notes infrastructure 120 may retrieve the IDs by either querying the container application 101 or by querying the active applications such as 140 and 150 directly. If the container application 101 or the applications 140 and 150 are not queryable, in one of the embodiments of the invention, the pinup notes infrastructure may include a special adapter for retrieving IDs of non-queryable applications.

The pin-up notes infrastructure 120 enables a user to record and manage unstructured data in the form of pin-up notes. As mentioned above, a pin-up note may be in any format supported by the system such as text data, voice recording, video recording, a presentation, a spreadsheet, etc. The user may generate a pin-up note in any of the supported formats and map it to a UI screen ID, object ID or an object instance ID. In one of the embodiments of the invention the user creates a pin-up note and then selects the data to which the pin-up note is to be mapped. The pin-up note infrastructure 120 then retrieves the ID of the selected data and maps the pin-up note to the ID. The pin-up note infrastructure 120 then stores the pin-up note along with its associated ID in the pin-up notes storage 131. FIG. 1 shows pin-up notes 121 and 123 after mapping with respective IDs. Categories 122 and 124 identify the types of IDs the notes are mapped to such as a UI screen ID, object ID or object instance ID.

In another embodiment of the invention the pin-up note infrastructure 120 automatically retrieves the IDs of a currently active or selected screen, data objects or object instances. The pin-up note infrastructure 120 then searches for the pin-up notes mapped to the retrieved IDs in the pin-up notes storages, retrieves them and displays them on the GUI 102.

In one embodiment, the pin-up notes infrastructure 120 operates transparently to the user. In addition, the pin-up notes infrastructure is not hard coded in any of the applications 101, 140, 150, and thus may be used with any existing applications.

In another embodiment of the invention the pin-up notes infrastructure 120 enables the user to edit or delete previously generated pin-up notes. The user may select a UI screen, a data object or an object instance and the pin-up notes infrastructure 120 retrieves all pin-up notes mapped to the corresponding ID. The user may then edit the pin-up note and save it back. The user may also search for pin-up notes directly in the pin-up notes storage, and retrieve and edit the pin-up notes.

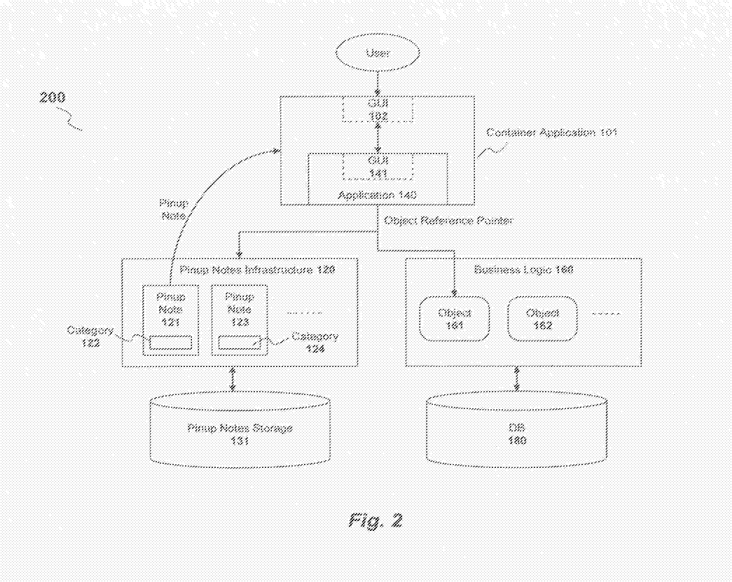

FIG. 2 illustrates an exemplary implementation of the system illustrated in FIG. 1. The container application 101 is a host for application 140. The GUI 141 of application 140 is linked to the container application GUI 102 and the user may see the GUI 141 as a screen in GUI 102. The user is thus able to work on GUI 141 to access application 140 and its associated objects 161 and 162. The user is now able to retrieve and manage pinup notes mapped to the UI screen 141, data objects 161 and 162 and instances of these data objects using the pin-up notes infrastructure 120.

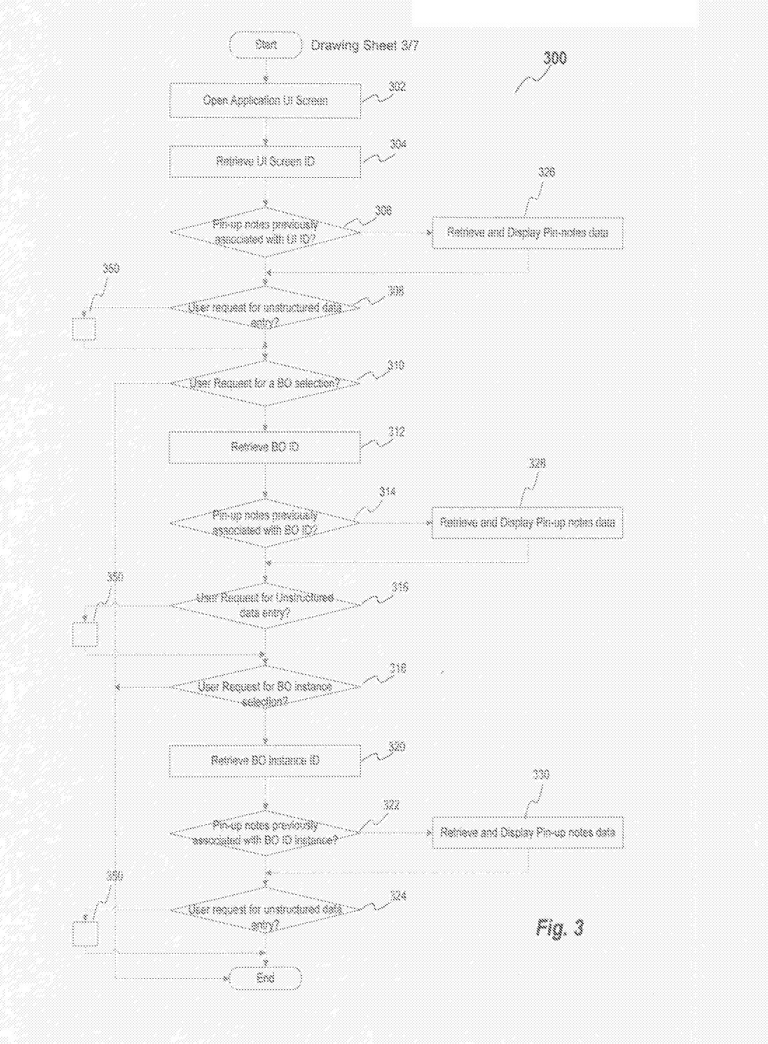

FIG. 3 is a flow diagram illustrating a high level process flow 300 for pin-up notes retrieval and generation according to a preferred embodiment of the invention. In process block 302 a UI screen of an application is retrieved on user request and displayed on the GUI 102 of the container application 101. In process block 304 the pin-up notes infrastructure retrieves the UI screen ID for the UI screen opened in process block 302. At 306, the pin-up notes infrastructure 120 checks whether there are any pin-up notes mapped to the UI screen ID. If there are any pin-up notes mapped to the UI screen ID, then the process continues to process block 326 wherein all the pin-up notes and the associated data mapped to the UI screen ID are retrieved and displayed to the user. Returning to decision block 306, if there are no pin-up notes associated with the UI screen ID, the process proceeds to decision block 308. In decision block 308, if the user makes a request for unstructured data entry (e.g., pin-up note entry), the process continues to process 350 wherein the user generates one or more pin-up notes and maps the pin-up nodes to a UI screen, data object or an object instance. The pin-up notes are stored in the pin-up notes storage 131. The process then continues to decision block 310. Returning to decision block 308, if there is no user request for pin-up notes entry, the process proceeds to decision block 310. In decision block 310, if the user does not request a data object selection, the process 300 is terminated. If the user does request a data object selection in decision block 310, the process continues to process block 312 where the pin-up notes infrastructure 120 retrieves the data object ID of the selected data object. At 314, the pin-up notes infrastructure 120 checks whether there are any pin-up notes mapped to the data object ID. If there are any pin-up notes mapped to the data object ID, then the process continues to process block 328 where all the pin-up notes and the associated data mapped to the data object ID are retrieved and displayed to the user. Returning to decision block 314, if there are no pin-up notes associated with the data object ID, the process proceeds to decision block 316. In decision block 316, if the user requests for an unstructured data entry (e.g., pin-up note entry), the process continues to process 350 wherein the user generates one or more pin-up notes and maps them to a UI screen, data object or an object instance. The pin-up notes are then stored in the pin-up notes storage 131. The process then continues to decision block 318. Returning to decision block 316, if there is no user request for pin-up notes entry, the process proceeds to decision block 318. In decision block 318, if the user does not request a data object instance selection, the process 300 is terminated. If the user does make a request for a data object instance selection in decision block 318, the process continues to process block 320 where the pin-up notes infrastructure 120 retrieves the data object instance ID of the selected data object instance. At 322, the pin-up notes infrastructure again checks whether there are any pin-up notes associated with the object instance ID. If there are any pin-up notes associated with the object instance ID, the process continues to process block 330 where the pin-up notes mapped to the data object ID are retrieved and displayed to the user. If there are no pin-up notes associated with the data object ID, then the process continues to decision block 324. In decision block 324, if the user requests a new pin-up notes entry, the process continues to process 350 wherein the user creates, maps and stores the new pin-up notes. The process is then terminated. Returning to decision block 324, if the user does not request for any pin-up notes entry, the process 300 is terminated.

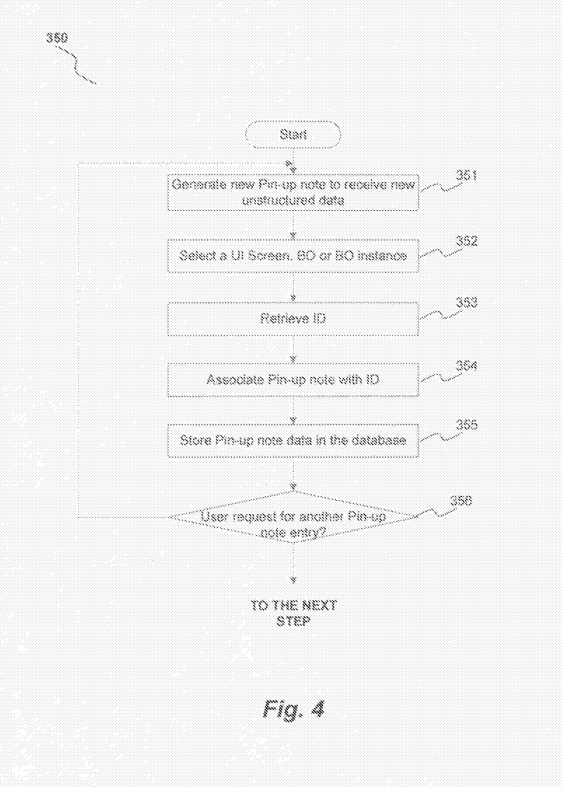

FIG. 4 illustrates a flow diagram of a process 350 for generating, mapping and storing pin-up notes. A new pin-up note is generated in process block 351 to record unstructured data (e.g., text, audio, video, etc). In process block 352 the user selects a UI screen, a data object or a data object instance for association with the pin-up note generated in process block 351. In process block 353, the pin-up notes infrastructure retrieves the ID for the selected UI screen, data object or data object instance from process block 352. The process 350 then continues to process block 354 where the pin-up note generated in process block 351 is mapped to the ID retrieved in process block 353 by the pin-up notes infrastructure 120. In decision block 356, if the user requests another pin-up notes entry, the process returns to process block 351. If the user does not make a request for another pin-up notes entry then the process 350 continues to the next decision block in process 300 or is terminated (refer to FIG. 3).

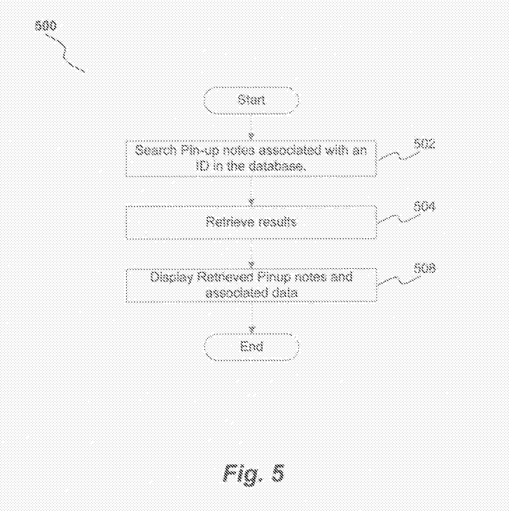

FIG. 5 illustrates a flow diagram of a process 500 for retrieval of pin-up notes mapped to an ID. In Process block 502, the pin-up notes infrastructure 120 searches the pin-up notes storage 131 for pin-up notes mapped to an ID. The results of the search are retrieved in process-block 504 and the pin-up note along with the associated data are displayed to the user through GUI 102 or application GUIs 141, 151, etc.

In one of the embodiments of the invention the user is provided with an action button on the GUI 102 to launch a separate application for generation and management of pinup notes. According to another embodiment of the invention the user is provided with one or more action buttons, each action button enabling the user to map pin-up notes to a different type of ID. For example the user may be provided with three action buttons AB1, AB2 and AB3. AB1 may enable a user to generate pin-up notes and map them to a UI screen ID. AB2 may enable the user to generate and map pin-up notes to an object type ID and AB3 may enable the user to generate and map pin-up notes to an object instance ID. Thus, by clicking an action button the user may first generate a pin-up note and then select a UI screen data object or object instance to which the pin-up note will be mapped. In another embodiment of the invention, the user may create a pin-up note and map it to a currently active or a selected object or object instance by selecting an attach menu option or by clicking an action button, or through any other designated UI element.

In an embodiment of the invention, at any point of time the user is provided with three separate action buttons to access and view the pin-up notes retrieved from the pin-up notes storage 131, each action button enabling the user to view pin-up notes associated to a different type of ID such as a UI screen ID, a data object ID or a data object instance ID. Thus, a user at any point of time may select an action button to view the pin-up notes associated to an ID type allocated to that action button.

In one embodiment, the pinup notes associated with a particular data object are automatically displayed in response to the user accessing the data object. For example, if the user views a structured data field to which a pin-up note is associated, the pin-up note will automatically be displayed for the user without the need for manual selection by the user (or played back in the case of audio or video pinup notes).

In another embodiment of the all the retrieved pin-up notes are presented to the user in a tabular format, with each pin-up note being displayed as a separate record entry along with its ID type. The user may then select each pin-up note to view it.

In one of the embodiment of the invention, the pin-up notes are assigned one or more attributes for identifying the users and/or computer systems associated with the pinup notes. The three particular attributes described below are referred to as “local and private,” “private” and “global.” Taking an example of a computer network having a number of client devices allocated to users, the pin-up notes having the “local and private” attribute are stored locally in the client devices of the users who have generated the notes. No other user in the network is allowed to access and view these pin-up notes. The pin-up notes having a “private” attribute are stored in a central server and are only made accessible to the user who generated the pin-up notes. In one embodiment, the user may access these notes from any client device in the network. The pin-up notes having a “global” attribute are stored in a central server and may be accessed and viewed by any user in the network from any client device. In one embodiment of the invention, the administrator of the computer network may be given rights to access and view the pin-up notes having any attribute, including the private attribute.

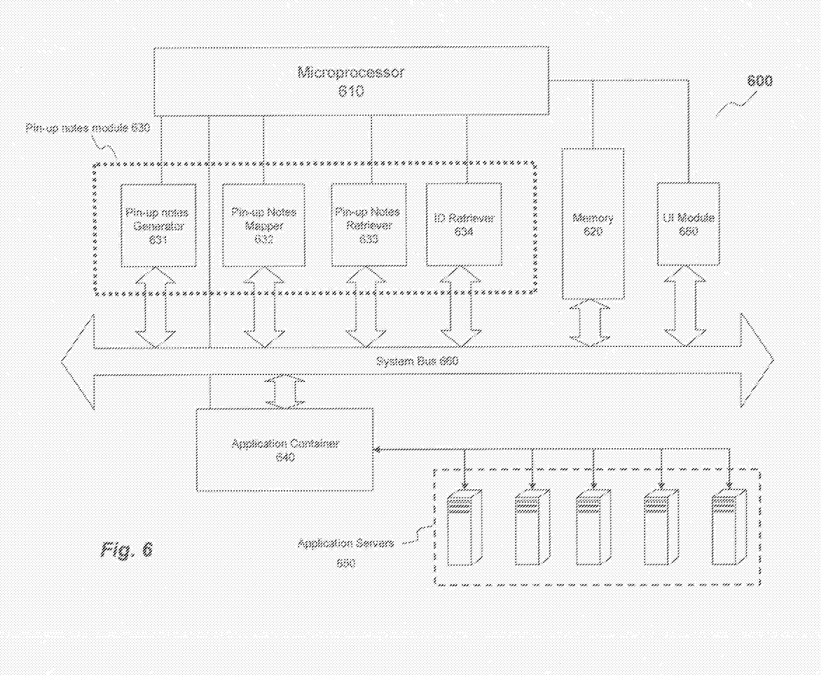

FIG. 6 illustrates an exemplary block diagram of a system 600 useful for implementing the invention according to a preferred embodiment of the invention. The system comprises a processor 610 that controls the entire system 600. The processor 610 is coupled to a memory 620 which is used to store data temporarily during processing. The pin-up notes module 630 includes a pin-up notes generator 631, a pin-up notes mapper 632, a pin-up notes retriever 633 and an ID retriever. The pin-up notes generator 631 is configured to generate user requested pin up notes and store them temporarily in the memory 620. The ID retriever 634 is configured to retrieve UI screen IDs, data object IDs and object instance IDs from applications (either container application 101 or applications 140, 150, etc) and store them temporarily in the memory 620. The pin-up notes retriever 633 is configured to retrieve pin-up notes mapped to an ID. As soon as a user selects a UI screen, a data object or an object instance, the processor 610 instructs the pin-up notes retriever to retriever all pin-up notes associated with the selected ID type. The pin-up notes infrastructure then picks up the requested ID retrieved and stored temporarily by the ID retriever 634 in the memory 620 and searches in the pin-up notes database (not shown) for the pin-up notes associated with the ID. The pin-up notes retriever 633 then retrieves and stores the pin-up notes associated with the ID in the memory 620. The user may access the memory 620 and view the retrieved pin-up notes any time. The pin-up notes mapper 632 is configured to map the pin-up notes generated by the user to an ID. As soon as the user selects a UI screen, data object or a data object instance, the processor 610 instructs the ID retriever 634 to retrieve the ID of the selected type and store it in the memory 620. The pin-up notes mapper then maps the generated pin-up note which is already stored in the memory 620 by the pin-up notes generator 631 to the ID. The pin-up note along with its associated ID is then stored in the pin-up notes data base (not shown). The UI module 660 is configured to control the user interface through which the user interacts with the system. The UI module 660 is responsible to control and manage both the GUI 102 of the container application 101 and GUIs 141, 151 of the applications 140 and 150. The application container 640 stores the container application 101. The application container 640 accesses applications from application servers 650.

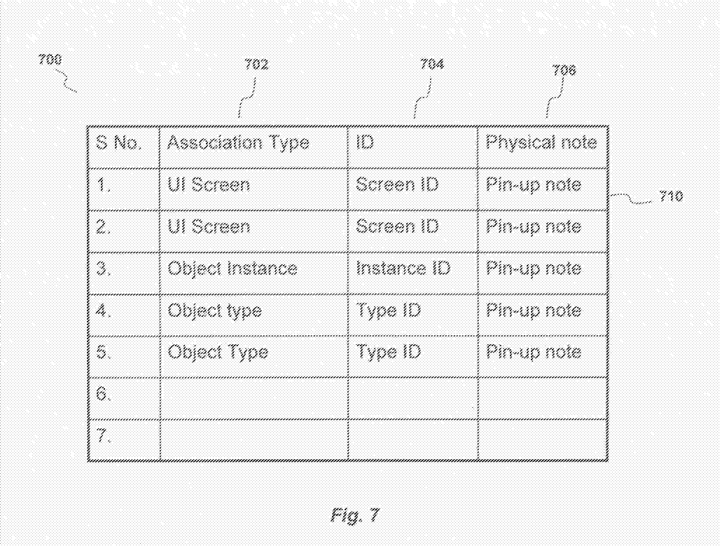

FIG. 7 illustrates a format in which the pin-up notes data is stored in the database according to a preferred embodiment of the invention. The pin-up notes data is stored in a tabular format 700. The table 700 comprises of three major columns, 702 storing association type, 704 storing the associated ID and 706 storing the physical pin-up note. Each pin-up note along with its association type and associated ID is stored as a separate record 710.

The particular methods associated with embodiments of the invention are described herein in terms of computer software and hardware with reference to flowcharts. The methods to be performed by a computing device (e.g., an application server) may constitute state machines or computer programs made up of computer-executable instructions. The computer-executable instructions may be written in a computer programming language or may be embodied in firmware logic. If written in a programming language conforming to a recognized standard, such instructions can be executed on a variety of hardware platforms and for interface to a variety of operating systems. In addition, embodiments of the invention are not described with reference to any particular programming language. It will be appreciated that a variety of programming languages may be used to implement the teachings of the invention as described herein. Furthermore, it is common in the art to speak of software, in one form or another (e.g., program, procedure, process, application, etc.), as taking an action or causing a result. Such expressions are merely a shorthand way of saying that execution of the software by a computing device causes the device to perform an action or produce a result.

Elements of the invention may also be provided as a machine-readable medium for storing the machine-executable instructions. The machine-readable medium may include, but is not limited to, flash memory, optical disks, CD-ROMs, DVD ROMs, RAMs, EPROMs, EEPROMs, magnetic or optical cards, propagation media or other type of machine-readable media suitable for storing electronic instructions. For example, the invention may be downloaded as a computer program which may be transferred from a remote computer (e.g., a server) to a requesting computer (e.g., a client) by way of data signals embodied in a carrier wave or other propagation medium via a communication link (e.g., a modem or network connection).

What is claimed is:

1. A method comprising:
providing a data identifier (ID) for a set of data, the set of data confirming to a predefined data structure (“structured data”);
retrieving one or more unstructured data objects mapped to the data identifier responsive to detecting that the structured data is being accessed, the unstructured data objects storing unstructured data related to the structured data;
generating an unstructured data object for storing unstructured data related to the structured data; and
mapping the unstructured data object to the data identifier.

2. The method of claim 1 further comprising:
providing a screen identifier for a screen containing structured data; and
mapping one or more of the unstructured data objects to the screen identifier.

3. The method of claim 1, wherein the structured data is selected from a group comprising user interface screen, Business Object and Business Object Instance.

4. The method of claim 1, wherein retrieving unstructured data objects further comprises:
searching for unstructured data objects that are mapped to a data identifier; and
retrieving all unstructured data objects that are mapped with the data identifier responsive to the step of searching.

5. The method of claim 1 further comprising:
providing a screen identifier for a screen containing structured data;
searching for unstructured data objects that are mapped to the screen identifier; and
retrieving all unstructured data objects that are mapped to the screen identifier responsive to the step of searching.

6. The method of claim 1, further comprising:
retrieving and displaying the unstructured data within the unstructured data objects when the structured data having its data identifier mapped to the unstructured data objects is displayed.

7. The method of claim 1, wherein the unstructured data objects are retrieved and displayed when the structured data having its data identifier mapped to unstructured data objects is made active data.

8. The method of claim 7, wherein the structured data is made active data by actions selected from a group consisting of selecting the structured data, clicking on the structured data, scrolling to the structured data and triggering an event on the structured data.

9. The method of claim 1, further comprising assigning attributes to the unstructured data objects.

10. The method of claim 9, wherein the attributes are selected from a group consisting of private, local and private and global wherein a private attribute indicates that the unstructured data object is accessible only by a creator of the unstructured data object from any computer system, a local and private attribute indicates that the unstructured data object is accessible only by the creator of the unstructured data object from a computer system on which the unstructured data object was originally created, and a global attribute indicates that the unstructured data object is accessible by any user from any computer system

11. The method of claim 1, wherein the unstructured data comprises text.

12. The method of claim 1, wherein the unstructured data comprises audio.

13. The method of claim 1, wherein the unstructured data comprises an instance of a business object.

14. A machine-accessible medium that provides instructions that, when executed by a machine, cause the machine to perform operations comprising:
providing a data identifier (ID) for a set of data, the set of data confirming to a predetermined data structure (“structured data”);
retrieving one or more unstructured data objects mapped to the data identifier responsive to detecting that the structured data is being accessed, the unstructured data objects storing unstructured data related to the structured data;
generating an unstructured data object for storing unstructured data related to the structured data; and
mapping the unstructured data object to the data identifier.

15. The machine-accessible medium of claim 14, further providing instructions which when executed by the machine, cause the machine to perform further operations comprising:
providing a screen identifier for a screen containing structured data; and
mapping one or more of the unstructured data objects to the screen identifier.

16. The machine-accessible medium of claim 14, wherein retrieving unstructured data objects further comprises:
searching for unstructured data objects that are mapped to a data identifier; and
retrieving all unstructured data objects that are mapped with the data identifier responsive to the step of searching.

17. The machine-accessible medium of claim 14, further providing instructions which when executed by the machine, cause the machine to perform further operations comprising:
providing a screen identifier for a screen containing structured data;
searching for unstructured data objects that are mapped to a screen identifier; and
retrieving all unstructured data objects that are mapped to the screen identifier responsive to the step of searching.

18. The machine-accessible medium of claim 14, further providing instructions which when executed by the machine, cause the machine to perform further operations comprising:
retrieving and displaying the unstructured data within the unstructured data objects when the structured data having its data identifier mapped to the unstructured data objects is displayed.

19. The machine-accessible medium of claim 14, wherein the unstructured data objects are retrieved and displayed when the structured data having its data identifier mapped to unstructured data objects is made active data.

20. The machine-accessible medium of claim 19, wherein the structured data is made active data by actions selected from a group consisting of selecting the structured data, clicking on the structured data, scrolling to the structured data and triggering an event on the structured data.

21. The machine-accessible medium of claim 14, further providing instructions which when executed by the machine, cause the machine to perform further operations comprising assigning attributes to the unstructured data objects.

22. The machine-accessible medium of claim 19, wherein the attributes are selected from a group consisting of private, local and private and global wherein a private attribute indicates that the unstructured data object is accessible only by a creator of the unstructured data object from any computer system, a local and private attribute indicates that the unstructured data object is accessible only by the creator of the unstructured data object from a computer system on which the unstructured data object was originally created, and a global attribute indicates that the unstructured data object is accessible by any user from any computer system.

23. A system comprising:
a processor having memory,
a pin-up notes module running on the processor, the pin-up notes module comprising:
an identifier (ID) retriever module to retrieve data identifiers (ID) for a set of data confirming to a predefined data structure (“structured data”) and store in the memory;
a pin-up notes generator module to generate unstructured data objects on user request and store the generated pin-up notes in the memory, the unstructured data objects storing unstructured data related to the structured data;
a pin-up notes mapper to map the unstructured data objects to the ID; and
a pin-up notes retriever module to retrieve the unstructured data objects associated with the ID;

24. The system of claim 23, further comprising a pin-up notes data base to store the generated unstructured data objects associated with the ID.

25. The system of claim 23, wherein the structured data is selected from a group comprising a User Interface screen data, a Business Object data and a Business Object Instance data.

26. The system of claim 23, further comprising a user interface (UI) module to control the pin-up notes user interface and enable the system to receive user requests.

27. The system of claim 21, further comprising:
an application container coupled to the pin-up notes module, the application container configured to access multiple applications; and
one or more servers coupled to the application container, each server storing one or more applications.
